(19) United States
(12) Patent Application Publication
(10) Pub. No.: US 2004/0227832 A1
(43) Pub. Date: Nov. 18, 2004

(54) Imaging system with individual pixel reset

(75) Inventor: Markus Loose, Thousand Oaks, CA (US)

Correspondence Address: KOPPEL, JACOBS, PATRICK & HEYBL, Suite 107, 555 St. Charles Drive, Thousand Oaks, CA, 91360, US

(73) Assignee: INNOVATIVE TECHNOLOGY LICENSING, LLC.

(21) Appl. No.: 10/436,946

(22) Filed: May 12, 2003

(51) Int. Cl. H04N 5/335

(52) U.S. Cl. 348/308

(57) ABSTRACT

Individual pixel reset circuits for an array of electromagnetic radiation sensors include a reset transistor connected to enable a reset of the pixel's sensor, and a logic gate connected to activate the reset transistor in response to a plurality of array reset signals. The logic gate can be implemented with only three transistors, and enables the selection of individual pixels for reset.

### BACKGROUND OF THE INVENTION 1. Field of the Invention

This invention relates to digital imaging devices, and more particularly to the resetting of individual pixels in an imaging sensor with minimal disruption to surrounding pixels.

2. Description of the Related Art

Imaging sensors are used in many applications such as digital cameras and camcorders, high definition television (HDTV) and telescopes. Two types of commonly used image sensors for these applications are charge coupled device (CCD) and complementary metal oxide semiconductor (CMOS). Each type of sensor includes a (typically) two-dimensional array of pixel circuits. Each pixel circuit includes an electromagnetic radiation detector which converts photons (electromagnetic radiation) into a charge which accumulates at the detector, and an output circuit. Each detector has a maximum charge that it will hold. Once this maximum charge is reached, the detector saturates and will not accumulate any additional charge.

Each pixel in a CMOS sensor senses one small area within the larger image, with its circuit outputting a signal representing that portion of the image. The pixel circuits may need to be reset from time to time, such as when a new image is to be obtained or when a bright star in an image has saturated the circuit.

Most imaging sensors reset one row of pixels at a time. With this method, only one transistor per pixel is needed to implement a reset. However, it is not applicable to situations in which it is desired to reset a portion of the array other than an entire row.

A conventional pixel with a row reset circuit is illustrated in FIG. 1. The pixel includes a photosensor 12 that accumulates charge in response to received radiation and a row reset transistor 14 that, when activated by a sufficient voltage on row reset control line 16, applies a reset voltage on reset voltage line 18 to sensor 12 to reset its voltage level. A voltage source 19 supplies line 18, providing sufficient current to reduce the voltage on the sensor to the voltage level of line 18. The reset voltage is typically a low voltage, such as 0-500 millivolts for a p-n type sensor. Sensor 12 may be a photodiode, phototransistor, or other type of photosensitive device.

A read transistor 20 and source follower transistor 22 have their source-drain circuits connected in series between a read bus 24 and the source-drain circuit of reset transistor 14. Source follower transistor 22 has its gate connected to output node 26 of sensor 12. The voltage at node 28, between read transistors 20 and 22, tracks the voltage at sensor node 26 through the normal source follower action of transistor 22. To read out a signal from the pixel, a voltage is applied to a read enable line 30 sufficient to activate read transistor 20, which then applies the sensor output voltage at node 28 to the read bus 24 through its activated source-drain circuit.

All of the pixels in the sensor include similar reset circuits. Each row of pixels has an associated row reset control line 16 which connects the gates of the row reset transistors in each pixel of the row. Each column of pixels has an associated reset voltage line 18 that, for each pixel in the column, connects to the side of the reset transistor 14 source-drain circuit opposite to detector node 26. With this configuration, only entire rows can be reset at a time.

Available imaging sensors which are configured to reset individual pixels employ a pair of reset transistors connected in series for each pixel, one for “row reset” and the other for “column reset,” as described in U.S. Pat. No. 5,881,184 to Guidash. Both transistors are activated to produce a reset. A negative aspect of the individual pixel reset capability is that it allows a parasitic capacitance to build up between the substrate and the node between the reset transistors when one of the transistors is activated but not the other. The voltage at this node is transmitted to the sensor and adds to the normal sensor output voltage, resulting in an erroneous output.

Such an individual pixel reset circuit is illustrated in FIG. 2. It adds a column reset control line 42 and column reset transistor 44 to a row reset circuit of FIG. 1, with the gate of transistor 44 connected to column reset control line 42 and its source-drain circuit connected between the source-drain circuit of row reset transistor 14 and the sensor output node 26. The remainder of the circuit is the same as in FIG. 1. With this configuration both reset transistors 14 and 44 must be turned on, by activating both the row reset line 16 and column reset control line 42, to apply the reset voltage on line 18 to sensor 12. This circuit can also introduce an undesirable parasitic capacitance between node 46, between the reset transistors 14 and 44, and the substrate. When row reset control line 16 is activated but column reset control line 42 is not, row reset transistor 14 turns on, setting the voltage at node 46 to the level of reset voltage line 18. Some charge remains at node 46, due to the parasitic capacitance, even after row reset control line 16 and row reset transistor 14 have been deactivated. Then, when column reset control line 42 and column reset transistor 44 are activated, the voltage at node 46 passes to sensor output node 26 and adds to the normal sensor output voltage, resulting in an erroneous output that can affect all pixels in the row and/or column of the reset pixel.

### SUMMARY OF THE INVENTION

The present invention overcomes the problems noted above. It provides an individual pixel reset circuit with a reset transistor that resets the sensor when it is activated, and a logic gate that is connected to activate the reset transistor in response to a plurality of reset signals.

In one embodiment, a reset transistor is connected between a reset voltage line and the sensor, with a logic gate that has three transistors and three logic inputs activating the reset transistor when it is desired to reset the sensor, and otherwise disconnecting the reset voltage line from the sensor. The logic gate activates the reset transistor in response to a combination of three reset signals.

One implementation of the logic gate includes a pair of opposite polarity CMOS transistors connected as a parallel switch between the first logic input and a control for the reset transistor, and a reset inhibit switch which has a control terminal connected in common with the gate of one of the CMOS transistors. The reset inhibit switch switches in an opposite manner to the one CMOS transistor in response to a signal at its control terminal to set the logic gate output to a reset inhibit voltage that deactivates the reset transistor when the CMOS transistors are off.

Further features and advantages of the invention will be apparent to those skilled in the art from the following detailed description, taken together with the accompanying drawings.

### BRIEF DESCRIPTION OF THE DRAWINGS

FIGS. 1 and 2 are schematic diagrams of prior pixel reset circuits;

FIG. 3 is a schematic diagram of an individual pixel reset circuit according to one embodiment of the invention;

FIG. 4 is a schematic diagram of a logic gate that can be used in the pixel reset circuit; and

FIG. 5 is a schematic diagram of a digital imaging system which uses the individual reset capability of the present invention.

### DETAILED DESCRIPTION OF THE INVENTION

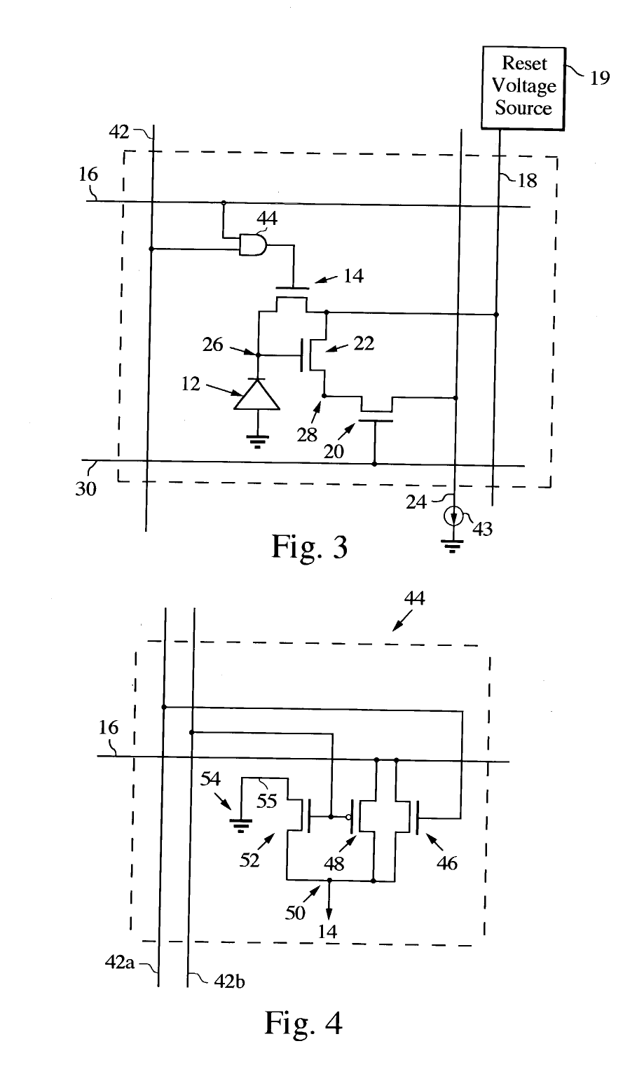

A pixel with an individual pixel reset circuit according to one embodiment of the invention is shown in FIG. 3. The pixel includes an electromagnetic radiation sensor 12, reset transistor 14, row reset control line 16, reset voltage line 18, reset voltage source 19, read transistor 20, source follower transistor 22, read bus 24, read enable line 30, and column reset control line 42 as in the prior circuit of FIG. 2. A keep-alive current source 43 maintains NMOS source follower transistor 22 in an active state. The direction of current flow would be reversed if a PMOS source follower were used.

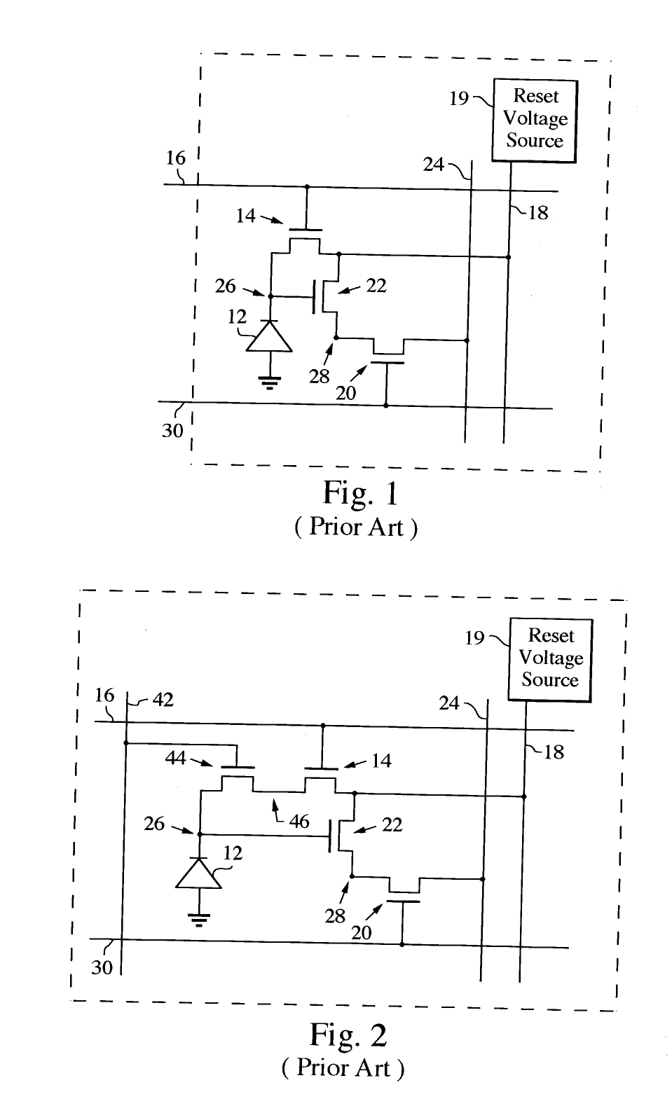

The invention is most commonly applicable to photosensitive detectors which are sensitive to visible light, infrared and/or ultraviolet, but it is also applicable to other regions of the electromagnetic spectrum. In contract to FIG. 2, a feature of the FIG. 3 circuit is that instead of the gate of reset transistor 14 being directly controlled by row reset line 16, a logic gate 44 has been added with its output connected to the gate of reset transistor 14. Logic gate 44 receives logic inputs from the row and column reset control lines 16 and 42. When both reset lines are activated, logic gate 44 activates reset transistor 14. This allows the voltage on sensor output node 26 to be set to the reset voltage on reset voltage line 18, as described above. With this configuration, no unwanted charge is introduced to the sensor and a more accurate voltage is read from sensor node 26. The voltage from electromagnetic radiation sensor 12 is read out in the same manner as described in connection with FIG. 1.

Logic gate 44 is preferably an AND gate, but other types of logic gates could be used that turn on reset transistor 14 in response to the activation of row reset control line 16 and column reset control line 42. The row and column reset control lines are typically “activated” by applying positive voltages to them, but activation could also occur in response to zero, negative, or opposite polarity voltages on the reset control lines, depending upon the nature of logic gate 44. For example, if a NOR gate is employed, reset transistor 14 would be activated in response to an absence of voltage on both reset lines. The type of logic gate used and the nature of the signals applied to the reset control lines also depend upon the nature of reset transistor 14. For example, if an nFET device is used instead of a pFET, logic gate 44 would need to provide an opposite polarity signal in response to the same inputs from the reset control lines to activate reset transistor 14.

FIG. 4 is a schematic diagram of one embodiment of logic gate 44 that uses only three transistors. This logic gate retains a single row reset control line 16, but instead of a single column reset control line 42 it employs complementary column reset control lines 42a and 42b. Complementary voltages are applied to lines 42a and 42b so that one line is active when the other is not. A pair of CMOS transistors 46 and 48 are connected as a parallel switch between row reset control line 16 and a reset node 50 that is connected to the gate of reset transistor 14. A reset inhibit transistor 52 of opposite doping type to transistor 46 has its gate connected to the gate of transistor 46, and its source-drain circuit connected between a reset inhibit voltage source 54, via line 55, and reset node 50. When column reset control line 42a is on and line 42b is off, the complementary transistors 46 and 48 are both turned on to pass any reset signal on row reset control line 16 to the reset node 50. If row reset control line 16 is activated at this time, reset transistor 14 is activated and a reset occurs. If row reset control line 16 is not activated, the voltage at reset node 50 will be too low to turn on reset transistor 14.

Both complementary transistors 46 and 48 are used to assure that the voltage at reset node 50 is held at the full voltage on reset control line 16. The CMOS transistors 46 and 48 typically have threshold voltages of 0.5-0.7 V, with nMOS transistor 46 turning on when its gate voltage exceeds its source voltage by the threshold amount, and pMOS transistor 48 turning on when its voltage exceeds its gate voltage by the threshold amount. Thus, as long as the difference between the complementary voltages on column reset control lines 42a and 42b is maintained at at least 1.4 volts when a reset is desired, it is assured that at least one of the transistors will conduct when row reset control line 16 is activated.

Transistors 46, 48 and 52 are shown as n-type, p-type and n-type respectively, but this could be reversed, with a corresponding reversal of signal polarities on column reset control lines 42a and 42b. Other types of switches, controlled by row and column reset control lines to transmit a reset signal to the pixel circuitry, could also be used, with the switch preferably transmitting the full voltage on row reset control line 16 to the gate of reset transistor 14.

Reset inhibit voltage source 54, when connected to reset node 50 through reset inhibit transistor 52, ensures that the voltage at reset node 50 is not floating when the complementary switch 46/48 is off, and is held below the voltage needed to activate reset transistor 14 so that the sensor is not inadvertently reset. Although reset inhibit voltage source 54 is shown as ground, it can provide any voltage level, such as 0-1 volt, that deactivates and holds reset transistor 14 off.

Current CMOS logic gates have at least four transistors. The three-transistor logic gate described herein reduces the number of components included in each pixel and thus the size of each pixel, enabling a higher resolution image sensor with a higher pixel density. The saving of at least one transistor per pixel is significant, since conventional image sensors can be very large, with multimillions of pixels.

The use of complementary control lines reduces circuit noise during individual pixel reset, since the noise associated with each line substantially cancels the noise associated with the other. A buildup of parasitic charge that can be added to the sensor during individual pixel reset is avoided with the addition of only two transistors compared to the prior circuit of FIG. 2.

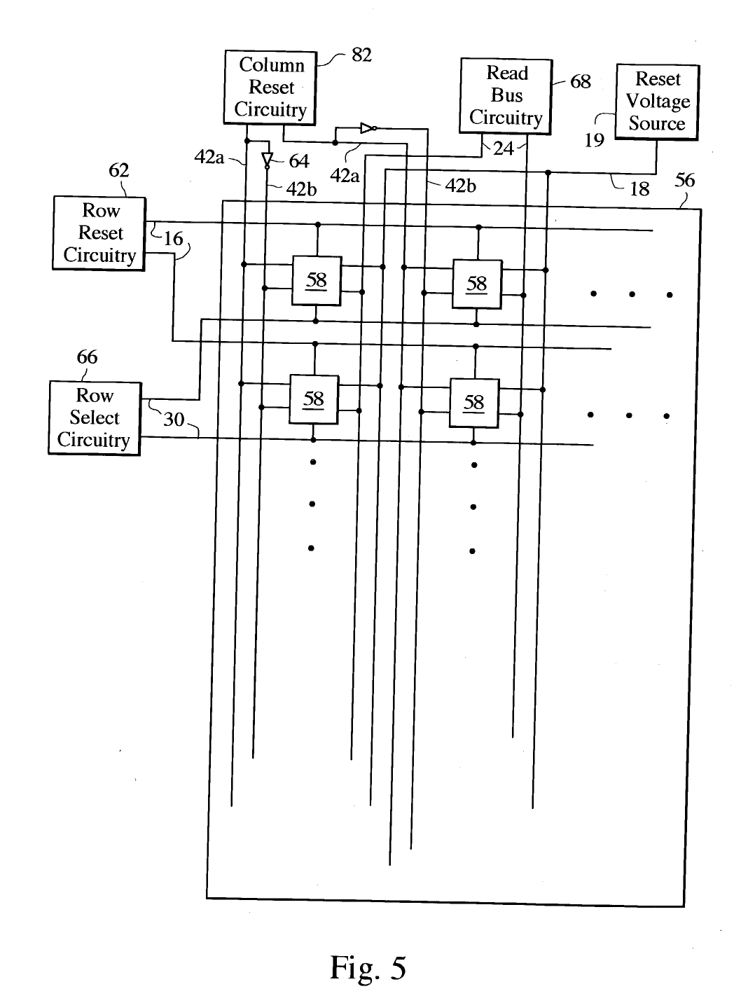

FIG. 5 illustrates a simplified imaging system with an array 56 of pixels 58 employing the reset scheme of FIG. 4. Pixels 58 are shown spaced widely apart for ease of illustrating the various signal lines, but in practice they would be much closer together. With conventional large pixel arrays, smaller pixel size and thus better resolution is enabled by the invention.

The imaging system includes column reset circuitry 60 and row reset circuitry 62 that activate desired sets of column reset control lines 42a and 42b and row reset control line 16, respectively, under the control of the user. Column reset control lines 42b are topped off of corresponding column reset control lines 42a, with a respective inverter 64 inserted into each line 42b to set each pair of column reset control lines 42a, 42b at complementary logic levels. Individual pixels are reset by activating their respective row and column reset control lines. Individual keep-alive current sources 43 could be provided for each pixel, but preferably a common keep-alive current source is provided for a full column or group of columns.

The system also includes row select circuitry 66 which activates the corresponding read enable line 30 to enable the read transistors 20 of the pixels in a selected row when the voltage from a desired pixel in the row is to be read out. Read bus circuitry 68 allows the sensor voltages from selected pixels in a selected row to be read out.

While particular embodiments of the invention have been shown and described, numerous variations and alternate embodiments will occur to those skilled in the art. For example, while an imaging array has been described in terms of rows and columns of pixels with specific row and column inputs and outputs, the row inputs and outputs could be exchanged with those for the columns, or other array geometries such as concentric circular or staggered pixels could be used. Also, while an FET has been shown in the reset inhibit circuit, other switches such as bipolar transistor could be used. A bipolar transistor substituted for reset inhibit transistor 52 would have its base control terminal connected to the gate of CMOS transistor 46, and be doped to switch opposite to CMOS transistors 46 and 48 so that the bipolar transistor was on when the CMOS transistors were off, and vice versa. Npn and pnp bipolar transistors could also be substituted for the CMOS transistors. Accordingly, it is intended that the invention be limited only in terms of the appended claims.

I claim:

1. An individual pixel reset circuit for an electromagnetic radiation sensor in an array of sensors, comprising:
a reset transistor connected to enable, when activated, a reset of said sensor, and
a logic gate connected to activate said reset transistor in response to a plurality of array reset signals.

2. The circuit of claim 1, further comprising a reset voltage line which is connectable to said sensor by said reset transistor to reset said sensor.

3. The circuit of claim 1, wherein said logic gate comprises three inputs and one output.

4. The circuit of claim 3, wherein said logic gate includes a reset inhibit voltage line which is connectable to said logic gate output to hold said reset transistor off.

5. The circuit of claim 4, wherein said logic gate comprises:
a pair of CMOS transistors connected as a parallel switch between said first logic input and a control for said reset transistor, and
a reset inhibit switch having a control terminal connected in common with the gate of one of said CMOS transistors, said reset inhibit switch switching in an opposite manner to said one CMOS transistor in response to a signal at its control terminal to connect said reset inhibit voltage line to said logic gate output when said CMOS transistors are off.

6. The circuit of claim 5, said reset inhibit switch comprising an FET of opposite doping type to the CMOS transistor to which its control terminal is connected.

7. The circuit of claim 1, wherein said logic gate comprises only three transistors.

8. The circuit of claim 7, further comprising a first logic input control circuit providing a first logic input for said logic gate, and a pair of second logic input control circuits providing a complementary pair of logic signals for the second and third logic inputs of said logic gate.

9. The circuit of claim 1, wherein said logic gate comprises an AND gate.

10. A reset circuit for a pixel that includes an electromagnetic radiation sensor, comprising:
a reset voltage line;
a reset transistor connected between said reset voltage line and said sensor; and
a logic gate having three transistors, three logic inputs and one output, said logic gate, when activated, activating said reset transistor to complete a connection between said reset voltage line and said sensor to reset said sensor, and to otherwise disconnect said reset voltage line from said sensor.

11. The circuit of claim 10, further comprising a first logic input control circuit providing a first logic input for said logic gate, and a pair of second logic input control circuits providing a complementary pair of logic input signals for the second and third logic inputs of said logic gate.

12. The circuit of claim 11, said logic gate comprising:
a pair of CMOS transistors connected as a parallel switch between said first logic input and a control for said reset transistor, and
a reset inhibit switch having a control terminal connected in common with the gate of one of said CMOS transistors, said reset inhibit switch switching in an opposite manner to said one CMOS transistor in response to a signal at its control terminal to connect a reset inhibit voltage line to said logic gate output when said CMOS transistors are off.

13. The circuit of claim 12, said reset inhibit switch comprising an FET of opposite doping type to the CMOS transistor to which its control terminal is connected.

14. The circuit of claim 12, wherein said reset inhibit voltage line is set at ground potential.

15. The logic gate of claim 12, wherein said logic gate output is activated in response to said first logic input and one of said pair of second logic inputs being activated.

16. The circuit of claim 12, wherein said pair of second logic input control circuits provide signals to the gates of said pair of CMOS transistors that, when activated, activate said CMOS transistors to connect said first logic input control circuit to said output.

17. The circuit of claim 12, wherein said first logic input control circuit is connected to the source-drain circuits of said CMOS transistors to activate said output when said first logic input control circuit and said CMOS transistors are activated.

18. An electromagnetic radiation sensing array, comprising:
an array of pixels, each pixel comprising:
an electromagnetic radiation sensor;
a reset transistor connected to enable, when activated, a reset of said sensor; and
a logic gate connected to activate said reset transistor in response to a plurality of array reset signals.

19. The array of claim 18, wherein each pixel in said array comprises:
a reset voltage line,
a reset transistor connected between said reset voltage line and said sensor, and
a logic gate having three transistors and three logic inputs, said logic gate, when activated, activating said reset transistor to complete a reset connection between said reset voltage line and said sensor.

20. The array of claim 19, further comprising a reset voltage source connected to said pixel reset voltage line.

21. The array of claim 18, further comprising pixel selection circuitry connected to address individual pixels for reset.

22. The array of claim 19, wherein said array is arranged in row and column coordinates, and further comprising a first logic input circuit that provides a reset signal to the logic gates of selectable pixels along one of said coordinates, and a second logic input circuit that provides a complementary pair of reset control signals to the logic gates of selectable pixels along the other of said coordinates.

23. A CMOS logic gate, comprising:
a pair of CMOS transistors connected as a parallel switch between a first logic input and an output for said logic gate, and
a further switch having a control terminal connected in common with the gate of one of said CMOS transistors,
said further switch connected to said logic gate output and switching in an opposite manner to said one CMOS transistor in response to a signal at its control terminal.

24. The logic gate of claim 23, said further switch comprising an FET of opposite doping type to the CMOS transistor to which its control terminal is connected.

25. The logic gate of claim 23, further comprising a first logic input circuit providing a first logic input to the source-drain circuits of said CMOS transistors, and a pair of second logic input circuits providing a complementary pair of logic inputs to the gates of respective ones of said CMOS transistors.

26. The logic gate of claim 27, wherein said output is activated in response to said first logic input being activated and said pair of second logic inputs activating said CMOS transistors.

27. The logic gate of claim 23, further comprising a source of fixed voltage, said further switch connected between said source and said logic gate output.
